(19) United States
(12) Patent Application Publication
(10) Pub. No.: US 2017/0188355 A1
(43) Pub. Date: Jun. 29, 2017

(54) VDC Resource Request Method, User Equipment, and Base Station

(71) Applicant: Huawei Technologies Co., Ltd., Shenzhen (CN)

(72) Inventor: Jie Ma, Beijing (CN)

(21) Appl. No.: 15/460,484

(22) Filed: Mar. 16, 2017

Related U.S. Application Data
(63) Continuation of application No. PCT/CN2015/078409, filed on May 6, 2015.

(30) Foreign Application Priority Data
Sep. 17, 2014 (CN) 201410474977.7

(51) Int. Cl. H04W 72/04; H04W 76/02; H04W 72/14

(52) U.S. Cl. CPC H04W 72/0413; H04W 72/14; H04W 76/023

(57) ABSTRACT

A VDC resource request method, user equipment, and a base station, where the VDC resource request method includes sending, by user equipment, a VDC resource request message to a base station when the user equipment needs to request a VDC resource for sending vehicle service information, where the VDC resource request message includes at least one piece of the following information: a VDC resource status list, or travel information of the user equipment, and an available VDC resource is indicated in the VDC resource status list, receiving a VDC resource allocation indication message from the base station, and sending the vehicle service information by using the VDC resource indicated by the VDC resource allocation indication message.

### CROSS-REFERENCE TO RELATED APPLICATIONS

This application is a continuation of International Application No. PCT/CN2015/078409, filed on May 6, 2015, which claims priority to Chinese Patent Application No. 201410474977.7, filed on Sep. 17, 2014. The disclosures of the aforementioned applications are hereby incorporated by reference in their entireties.

### TECHNICAL FIELD

The present invention relates to the communications field, and specifically, to a vehicle direct communication (VDC) resource request method, user equipment, and a base station.

### BACKGROUND

In the Internet of Vehicles, that is, a network in which vehicles are connected to each other, a mobile communications module is installed on a vehicle terminal, and communication between vehicles can be implemented by using a mobile communications network.

There are three types of vehicle service information in the Internet of Vehicles. A first type of vehicle service information is an information entertainment service, and a user in a vehicle can perform various entertainment activities by using the Internet of Vehicles. A second type of vehicle service information is a vehicle efficiency-type information service, and the information is released by a road management department or a road traffic participant and mainly includes road congestion information, road construction information, and information such as speed limitation on a road section, weather on a road section, or whether a road is available for passage. A third type of vehicle service information is a vehicle safety message, for example, including emergency brake information of a vehicle, or information prompting a coming vehicle from an opposite side when a vehicle is making a turn, and the vehicle safety message is mainly used to avoid a vehicle collision.

The first type of vehicle service information and the second type of vehicle service information may be obtained from the cloud in a communication manner such as by using the third generation mobile communications network (that is, 3G) or the fourth generation mobile communications network (that is, 4G). Therefore, a network with a wide coverage area needs to be used.

For the third type of vehicle service information, because the third type of vehicle service information is travel information of a vehicle, and the vehicle is usually in fast move, transmission of the third type of vehicle service information requires a relatively small transmission delay (the transmission delay is usually required to be less than 100 milliseconds), so as to avoid collision. Coverage of a cellular network is excessively wide, and a link establishment process is relatively complex. Therefore, a transmission delay of the cellular network is relatively large. If the third type of vehicle service information is transmitted by using a cellular network such as the 3G or 4G, a transmission delay requirement of the third type of vehicle service information cannot be satisfied. When a transmission delay does not satisfy the transmission delay requirement of the third type of vehicle service information, the third type of vehicle service information may not be sent to a vehicle terminal in time. Consequently, a traffic accident may be caused.

### SUMMARY

The present invention provides a VDC resource request method, user equipment, and a base station, to reduce a vehicle service information transmission delay.

A first aspect of the present invention provides a VDC resource request method, including sending, by the user equipment, a VDC resource request message to a base station when the user equipment needs to request a VDC resource for sending vehicle service information, where the VDC resource request message includes at least one piece of the following information: the VDC resource status list, or travel information of the user equipment, and an available VDC resource is indicated in the VDC resource status list, receiving, by the user equipment, a VDC resource allocation indication message from the base station, where the VDC resource allocation indication message indicates a VDC resource allocated to the user equipment by the base station according to the VDC resource request message, and sending, by the user equipment, the vehicle service information by using the VDC resource indicated by the VDC resource allocation indication message.

Based on the first aspect of the present invention, in a first possible implementation manner, the VDC resource request message includes the VDC resource status list. The method further includes monitoring, by the user equipment, a VDC resource use status, and updating, by the user equipment, the locally stored VDC resource status list when monitoring a change of the VDC resource use status.

Based on the first possible implementation manner of the first aspect of the present invention, in a second possible implementation manner, the monitoring, by the user equipment, a vehicle direct communication VDC resource use status includes obtaining VDC resource parameter information that is broadcast by the base station, where the VDC resource parameter information includes VDC resource bandwidth, VDC resource channel division, and a channel parameter, and monitoring the VDC resource use status according to the obtained VDC resource parameter information.

Based on the first aspect of the present invention, the first possible implementation manner of the first aspect of the present invention, or the second possible implementation manner of the first aspect of the present invention, in a third possible implementation manner, before the sending, by the user equipment, a VDC resource request message to a base station, the method includes sending, by the user equipment, a predetermined access preamble sequence to the base station, so that the base station learns, according to the predetermined access preamble sequence, that the user equipment currently needs to apply for a VDC resource, and allocates an uplink grant value to the user equipment, and receiving an access acknowledgment message from the base station, where the access acknowledgment message includes the uplink grant value allocated to the user equipment by the base station. The sending, by the user equipment, a VDC resource request message to a base station includes sending, by the user equipment, the VDC resource request message to the base station according to the uplink grant value in the access acknowledgment message.

A second aspect of the present invention protects another VDC resource request method, including receiving a VDC resource request message from user equipment, where the VDC resource request message includes at least one piece of the following information: a VDC resource status list, or travel information of the user equipment, and an available VDC resource is indicated in the VDC resource status list, allocating a currently available VDC resource to the user equipment according to the VDC resource request message of the user equipment, and sending a VDC resource allocation indication message to the user equipment, where the VDC resource allocation indication message indicates the VDC resource allocated to the user equipment by the base station, so that the user equipment sends vehicle service information by using the VDC resource indicated by the VDC resource allocation indication message.

Based on the second aspect of the present invention, in a first possible implementation manner, the VDC resource request message includes the VDC resource status list. Before the receiving a VDC resource request message from user equipment, the method further includes broadcasting VDC resource parameter information to user equipment within a coverage area of the base station, where the VDC resource parameter information includes VDC resource bandwidth, VDC resource channel division, and a channel parameter.

Based on the second aspect of the present invention, in a second possible implementation manner, the VDC resource request message includes the travel information of the user equipment, and the travel information includes vehicle speed information of a vehicle on which the user equipment is located, and the allocating a currently available VDC resource to the user equipment according to the VDC resource request message of the user equipment includes determining a VDC resource range according to a vehicle speed interval of the vehicle speed information of the vehicle on which the user equipment is located, where there is a correspondence between the vehicle speed interval and the VDC resource range, and allocating the currently available VDC resource in the determined VDC resource range to the user equipment.

Based on the second aspect of the present invention, the first possible implementation manner of the second aspect of the present invention, or the second possible implementation manner of the second aspect of the present invention, in a third possible implementation manner, the method further includes, receiving VDC resource occupation indication information from a neighboring base station, where the VDC resource occupation indication information of the neighboring base station is used to indicate an occupied VDC resource within a coverage area of the neighboring base station, and the allocating a currently available VDC resource to the user equipment according to the VDC resource request message of the user equipment includes allocating the currently available VDC resource to the user equipment according to the VDC resource request message of the user equipment and the VDC resource occupation indication information of the neighboring base station.

Based on the second aspect of the present invention, the first possible implementation manner of the second aspect of the present invention, or the second possible implementation manner of the second aspect of the present invention, in a fourth possible implementation manner, before the receiving a vehicle direct communication VDC resource request message from user equipment, the method includes receiving an access preamble sequence of the user equipment, allocating an uplink grant value to the user equipment when it is determined that the access preamble sequence is a predetermined access preamble sequence, and sending an access acknowledgment message to the user equipment, where the access acknowledgment message includes the uplink grant value allocated to the user equipment by the base station.

Based on the fourth possible implementation manner of the second aspect of the present invention, in a fifth possible implementation manner, the access preamble sequence of the user equipment is further used to indicate a quantity of bytes that are sent at the request of the user equipment, and the allocating an uplink grant value to the user equipment includes: allocating, to the user equipment according to the access preamble sequence of the user equipment, an uplink grant value greater than or equal to the quantity of bytes that are sent at the request of the user equipment.

A third aspect of the present invention provides user equipment, including a sending unit, configured to send a VDC resource request message to a base station when the user equipment needs to request a VDC resource for sending vehicle service information, where the VDC resource request message includes at least one piece of the following information: the VDC resource status list, or travel information of the user equipment, and an available VDC resource is indicated in the VDC resource status list, and a receiving unit, configured to receive a VDC resource allocation indication message from the base station, where the VDC resource allocation indication message indicates a VDC resource allocated to the user equipment by the base station according to the VDC resource request message. The sending unit is further configured to send the vehicle service information by using the VDC resource indicated by the VDC resource allocation indication message.

Based on the third aspect of the present invention, in a first possible implementation manner, the VDC resource request message includes the VDC resource status list. The user equipment further includes a monitoring unit, configured to monitor a vehicle direct communication VDC resource use status, and an updating unit, configured to update the locally stored VDC resource status list when the monitoring unit monitors a change of the VDC resource use status.

Based on the first possible implementation manner of the third aspect of the present invention, in a second possible implementation manner, the monitoring unit includes an obtaining unit, configured to obtain VDC resource parameter information that is broadcast by the base station, where the VDC resource parameter information includes VDC resource bandwidth, VDC resource channel division, and a channel parameter, and a monitoring subunit, configured to monitor the VDC resource use status according to the VDC resource parameter information obtained by the obtaining unit.

Based on the third aspect of the present invention, the first possible implementation manner of the third aspect of the present invention, or the second possible implementation manner of the third aspect of the present invention, in a third possible implementation manner, the sending unit is further configured to send a predetermined access preamble sequence to the base station before sending the VDC resource request message to the base station, so that the base station learns, according to the predetermined access preamble sequence, that the user equipment currently needs to apply for a VDC resource, and allocates an uplink grant value to the user equipment. The receiving unit is further configured to receive an access acknowledgment message from the base station, and the access acknowledgment message includes the uplink grant value allocated to the user equipment by the base station, and the sending unit is configured to send the VDC resource request message to the base station according to the uplink grant value in the access acknowledgment message.

A fourth aspect of the present invention provides a base station, including a first receiving unit, configured to receive a vehicle direct communication VDC resource request message from user equipment, where the VDC resource request message includes at least one piece of the following information: a VDC resource status list, or travel information of the user equipment, and an available VDC resource is indicated in the VDC resource status list, a first allocation unit, configured to allocate a currently available VDC resource to the user equipment according to the VDC resource request message of the user equipment received by the first receiving unit, and a first sending unit, configured to send a VDC resource allocation indication message to the user equipment, where the VDC resource allocation indication message indicates the VDC resource allocated to the user equipment by the first allocation unit, so that the user equipment sends vehicle service information by using the VDC resource indicated by the VDC resource allocation indication message.

Based on the fourth aspect of the present invention, in a first possible implementation manner, the VDC resource request message includes the VDC resource status list. The base station further includes a broadcasting unit, configured to broadcast VDC resource parameter information to user equipment within a coverage area of the base station, where the VDC resource parameter information includes VDC resource bandwidth, VDC resource channel division, and a channel parameter.

Based on the fourth aspect of the present invention, in a second possible implementation manner, the VDC resource request message includes the travel information of the user equipment, and the travel information includes a vehicle speed of a vehicle on which the user equipment is located. The first allocation unit is configured to determine a VDC resource range according to a vehicle speed interval of the vehicle speed information of the vehicle on which the user equipment is located, and allocate the currently available VDC resource in the determined VDC resource range to the user equipment, where there is a correspondence between the vehicle speed interval and the VDC resource range.

Based on the fourth aspect of the present invention, the first possible implementation manner of the fourth aspect of the present invention, or the second possible implementation manner of the fourth aspect of the present invention, in a third possible implementation manner, the base station further includes a second receiving unit, configured to receive VDC resource occupation indication information from a neighboring base station, where the VDC resource occupation indication information of the neighboring base station is used to indicate an occupied VDC resource within a coverage area of the neighboring base station. The first allocation unit is configured to allocate the currently available VDC resource to the user equipment according to the VDC resource request message of the user equipment and the VDC resource occupation indication information of the neighboring base station.

Based on the fourth aspect of the present invention, the first possible implementation manner of the fourth aspect of the present invention, or the second possible implementation manner of the fourth aspect of the present invention, in a fourth possible implementation manner, the base station further includes a third receiving unit, configured to receive an access preamble sequence of the user equipment, a second allocation unit, configured to allocate an uplink grant value to the user equipment when it is determined that the access preamble sequence is a predetermined access preamble sequence, a determining unit, configured to determine a time advance of the user equipment, and a second sending unit, configured to send an access acknowledgment message to the user equipment, where the access acknowledgment message includes the time advance of the user equipment and the uplink grant value allocated to the user equipment by the base station.

Based on the fourth possible implementation manner of the fourth aspect of the present invention, in a fifth possible implementation manner, the access preamble sequence of the user equipment is further used to indicate a quantity of bytes that are sent at the request of the user equipment. The second allocation unit is configured to allocate, to the user equipment according to the access preamble sequence of the user equipment received by the third receiving unit, an uplink grant value greater than or equal to the quantity of bytes that are sent at the request of the user equipment.

It may be learned from the foregoing technical solutions of the present invention that user equipment sends a VDC resource request message to a base station when the user equipment needs to send vehicle service information (for example, when the user equipment needs to send a third type of vehicle service information that requires a small transmission delay), so that the base station allocates an available VDC resource to the user equipment according to the VDC resource request message. Then, the user equipment sends the vehicle service information by using the VDC resource allocated by the base station. In an entire process, no complex link establishment process between the user equipment and the base station is required. Therefore, a vehicle service information transmission delay is effectively reduced. Moreover, experimental research data shows that a transmission delay can be less than 100 milliseconds when vehicle service information is transmitted according to the present invention, that is, a transmission delay requirement of the third type of vehicle service information can be satisfied.

### BRIEF DESCRIPTION OF THE DRAWINGS

To describe the technical solutions in the embodiments of the present invention more clearly, the following briefly describes the accompanying drawings required for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 is a schematic flowchart of an embodiment of a VDC resource request method according to the present invention;

FIG. 2 is a schematic flowchart of another embodiment of a VDC resource request method according to the present invention;

FIG. 3 is a schematic flowchart of still another embodiment of a VDC resource request method according to the present invention;

FIG. 4 is a schematic flowchart of still another embodiment of a VDC resource request method according to the present invention;

FIG. 5 is a schematic flowchart of still another embodiment of a VDC resource request method according to the present invention;

FIG. 6 is a schematic flowchart of still another embodiment of a VDC resource request method according to the present invention;

FIG. 7 is a schematic structural diagram of an embodiment of user equipment according to the present invention;

FIG. 8 is a schematic structural diagram of another embodiment of user equipment according to the present invention;

FIG. 9 is a schematic structural diagram of still another embodiment of user equipment according to the present invention;

FIG. 10 is a schematic structural diagram of an embodiment of a base station according to the present invention; and

FIG. 11 is a schematic structural diagram of another embodiment of a base station according to the present invention.

### DETAILED DESCRIPTION OF ILLUSTRATIVE EMBODIMENTS

To make the invention objectives, features, and advantages of the present invention clearer and more comprehensible, the following clearly describes the technical solutions in the embodiments of the present invention with reference to the accompanying drawings in the embodiments of the present invention. Apparently, the embodiments described are merely a part rather than all of the embodiments of the present invention. All other embodiments obtained by persons of ordinary skill in the art based on the embodiments of the present invention without creative efforts shall fall within the protection scope of the present invention.

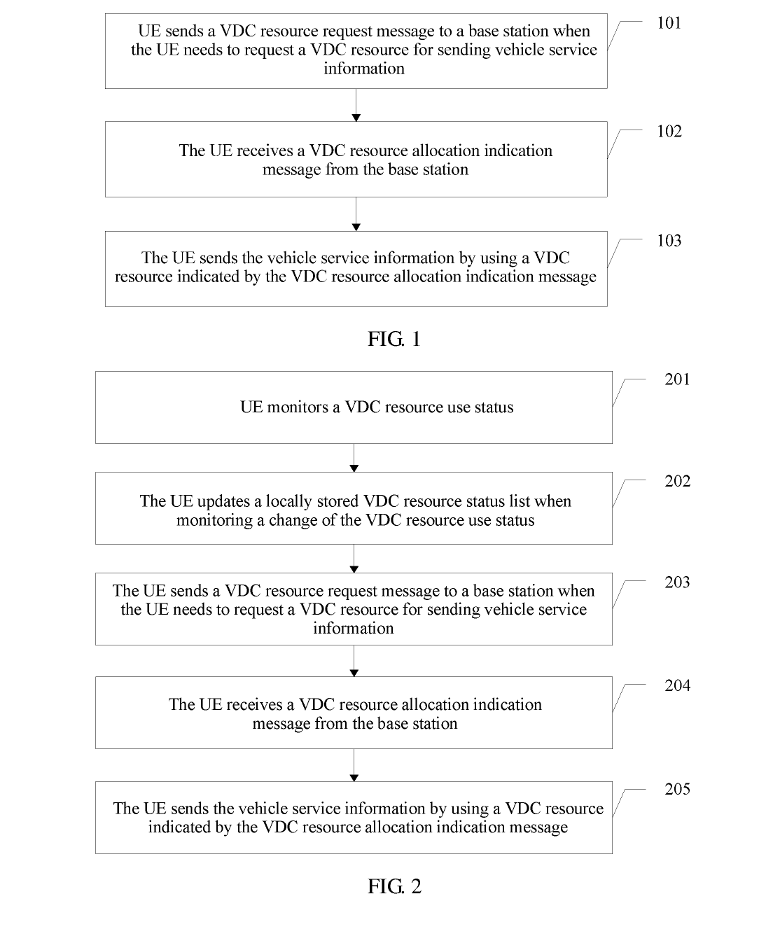

The following describes a VDC resource request method performed by user equipment (UE) in an embodiment of the present invention. Referring to FIG. 1, the VDC resource request method according to this embodiment of the present invention includes the following steps.

101. UE sends a VDC resource request message to a base station when the UE needs to request a VDC resource for sending vehicle service information.

The VDC resource request message includes at least one piece of the following information: a VDC resource status list, or travel information of the UE. An available VDC resource is indicated in the VDC resource status list.

In this embodiment of the present invention, VDC is a vehicle direct communication technology designed based on a physical layer of a Long Term Evolution (LTE) system, that is, VDC communication is direct communication between UE and UE. A feature of the VDC communication is as follows: A base station configures an independent VDC resource for each cell, and each UE (for example, a vehicle-mounted terminal or a handheld terminal) may obtain VDC resource parameter information by receiving a configuration message that is broadcast by the base station or by establishing a dedicated link to the base station. The VDC resource parameter information is, for example, total bandwidth of VDC resources within a coverage area of the base station, a time-frequency resource configuration parameter of a channel corresponding to each VDC resource, or a channel identifier (for example, a channel number) of a channel corresponding to a VDC resource that can be used by each UE. When sending a vehicle safety message, the UE needs to use only a VDC resource allocated to the UE by the base station. In addition, the UE needs to receive as many signals on the VDC resource as possible, so as to receive as many vehicle safety messages sent by other neighboring UE as possible. The vehicle safety message includes, for example, emergency brake information of a vehicle, or information prompting a coming vehicle at an opposite side when a vehicle is making a turn. The vehicle safety message is mainly used to avoid vehicle collision.

Optionally, the UE may locally maintain the VDC resource status list on the UE by monitoring a VDC resource use status, and sends, to the base station when the UE needs to request the VDC resource for sending the vehicle service information, the VDC resource request message that carries the locally maintained VDC resource status list, so that the base station allocates the VDC resource to the UE according to the VDC resource status list.

Optionally, the VDC resource request message further includes a radio network temporary identifier (RNTI) of the UE, and the RNTI is allocated to the UE by the base station when the UE is accessing a cellular network.

Optionally, the travel information includes one or more pieces of the following information: vehicle speed information of a vehicle on which the UE is located, or geographical location information and/or a travel direction of a vehicle on which the UE is located.

In this embodiment of the present invention, the UE requests the VDC resource mainly for sending a third type of vehicle service information. Certainly, the UE may request the VDC resource for sending other vehicle service information.

Optionally, the UE is connected to a control management system of the vehicle on which the UE is located. The UE may obtain the travel information (for example, the vehicle speed information, brake information, or turning information) of the vehicle from the control management system of the vehicle on which the UE is located. Optionally, the UE may obtain, by using a positioning module (for example, a Global Positioning System (GPS) module) configured on the UE, the geographical location information, the travel direction, or the like of the vehicle on which the UE is located. The UE generates one or more pieces of third type of vehicle service information according to the obtained geographical location information, travel direction, travel information, or the like of the vehicle. Each time the UE generates one piece of third type of vehicle service information, the UE requests a VDC resource from the base station for sending the generated third type of vehicle service information. In this embodiment of the present invention, the UE sends the VDC resource request message to the base station. It should be noted that the third type of vehicle service information in this embodiment of the present invention may be generated with reference to an existing manner for generating a third type of vehicle service information, and details are not described herein.

102. The UE receives a VDC resource allocation indication message from the base station.

The VDC resource allocation indication message indicates a VDC resource allocated to the UE by the base station according to the VDC resource request message.

103. The UE sends the vehicle service information by using a VDC resource indicated by the VDC resource allocation indication message.

It should be noted that the UE in this embodiment of the present invention may be a vehicle-mounted terminal, a handheld terminal, or another terminal that can be connected to a vehicle control management system, and is not limited herein.

It may be learned from the foregoing technical solution of the present invention that, in the present invention, user equipment sends a VDC resource request message to a base station when the user equipment needs to send vehicle service information (for example, when the user equipment needs to send a third type of vehicle service information that requires a small transmission delay), so that the base station allocates an available VDC resource to the user equipment according to the VDC resource request message. Then, the user equipment sends the vehicle service information by using the VDC resource allocated by the base station. In an entire process, no complex link establishment process between the user equipment and the base station is required. Therefore, a vehicle service information transmission delay is effectively reduced. Moreover, experimental research data shows that a transmission delay can be less than 100 milliseconds when vehicle service information is transmitted according to the present invention, that is, a transmission delay requirement of the third type of vehicle service information can be satisfied.

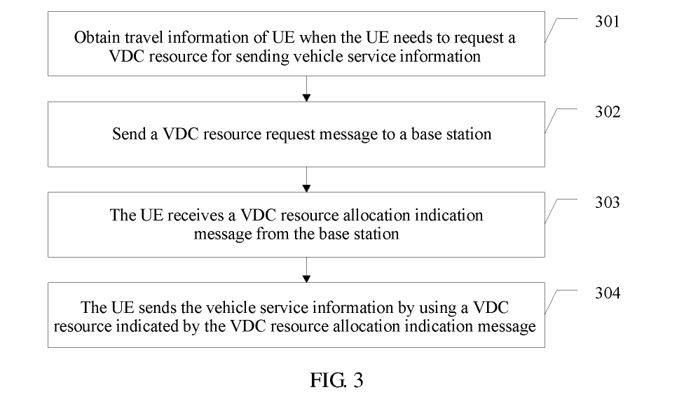

The following further describes a VDC resource request method performed by UE in an embodiment of the present invention. In this embodiment of the present invention, a VDC resource request message carries a VDC resource status list. Referring to FIG. 2, the VDC resource request method according to this embodiment of the present invention includes the following steps.

201. UE monitors a VDC resource use status.

In this embodiment of the present invention, VDC is a vehicle direct communication technology designed based on a physical layer of an LTE system, that is, VDC communication is direct communication between UE and UE. A feature of the VDC communication is as follows: A base station configures an independent VDC resource for each cell, and each UE (for example, a vehicle-mounted terminal or a handheld terminal) may obtain VDC resource parameter information by receiving a configuration message that is broadcast by the base station or by establishing a dedicated link to the base station. The VDC resource parameter information is, for example, total bandwidth of VDC resources within a coverage area of the base station, a time-frequency resource configuration parameter of a channel corresponding to each VDC resource, or a channel identifier (for example, a channel number) of a channel corresponding to a VDC resource that can be used by each UE. When sending a vehicle safety message, the UE needs to use only a VDC resource allocated to the UE by the base station. In addition, the UE needs to receive as many signals on the VDC resource as possible, so as to receive as many vehicle safety messages sent by other neighboring UE as possible. The vehicle safety message includes, for example, emergency brake information of a vehicle, or information prompting a coming vehicle at an opposite side when a vehicle is making a turn. The vehicle safety message is mainly used to avoid vehicle collision.

In this embodiment of the present invention, the base station manages a VDC resource, but the VDC resource may not be a resource used for cellular communication between the base station and the UE. For example, a cellular communication resource between the base station and the UE is a spectrum of 2.6 gigahertz (that is, GHz), and the VDC resource is a spectrum of 5.9 GHz; or a cellular communication resource between the base station and the UE is a frequency division duplex (FDD, Frequency Division Duplex) spectrum of 2.6 gigahertz, and the VDC resource is a time division duplex (TDD, Time Division Duplexing) spectrum of 2.6 GHz.

Optionally, the base station broadcasts the VDC resource parameter information on a broadcast channel (BCH of a cellular communication resource spectrum. The VDC resource parameter information includes VDC resource bandwidth, VDC resource channel division, and a channel parameter. The channel parameter includes but is not limited to a channel time-domain resource, a channel frequency-domain resource, a channel retransmission moment, a channel modulation and coding scheme, and the like. In this way, all UEs in the coverage area of the base station can obtain the VDC resource parameter information that is broadcast by the base station, and starts to monitor a VDC resource use status in the coverage area of the base station according to the obtained VDC resource parameter information, so as to learn a currently occupied VDC resource and a currently idle (that is, available) VDC resource in the coverage area of the base station. Alternatively, in this embodiment of the present invention, the base station may not broadcast VDC resource parameter information. When the UE enters the coverage area of the base station, the UE requests the VDC resource parameter information from the base station, and the base station sends the VDC resource parameter information to the UE after receiving a request of the UE, so that the UE monitors a VDC resource use status. Certainly, the UE may monitor the VDC resource use status in a manner other than the foregoing two manners. This is not limited herein.

It should be noted that, in this embodiment of the present invention, a criterion for determining that a VDC resource is occupied is that the UE detects that energy on the VDC resource is greater than a preset threshold, and a criterion for determining that a VDC resource is idle is that the UE detects that energy on the VDC resource is not greater than the preset threshold. That is, when detecting that energy on a VDC resource is greater than the preset threshold, the UE determines that the VDC resource is currently occupied; when detecting that energy on a VDC resource is not greater than the preset threshold, the UE determines that the VDC resource is currently idle. The energy is usually represented by a power value.

202. The UE updates a locally stored VDC resource status list when monitoring a change of the VDC resource use status.

An available VDC resource is indicated in the VDC resource status list.

For example, it is assumed that there are four channels, channel numbers are separately 5, 6, 7, and 9, and the four channels are separately corresponding to different VDC resources. A VDC resource status list maintained by UE 1 is shown in Table 1.

TABLE 1

| Channel number | Status |
|---|---|
| 5 | Idle |
| 6 | Occupied |
| 7 | Idle |
| 9 | Occupied |

In Table 1, a VDC resource corresponding to a channel in an idle state is a VDC resource currently available to the UE 1, and a VDC resource corresponding to a channel in an occupied state is a VDC resource currently unavailable to the UE 1.

When the UE 1 monitors a change of a VDC resource use status, for example, the UE 1 learns, by means of monitoring, that a VDC resource corresponding to a channel whose channel number is 5 is occupied and a VDC resource corresponding to a channel whose channel number is 6 is not occupied, the UE 1 updates the VDC resource status list in Table 1. The updated VDC resource status list is shown in Table 2.

TABLE 2

| Channel number | Status |
|---|---|
| 5 | Occupied |
| 6 | Idle |
| 7 | Idle |
| 9 | Occupied |

203. The UE sends a VDC resource request message to a base station when the UE needs to request a VDC resource for sending vehicle service information.

The VDC resource request message includes the VDC resource status list.

Optionally, the VDC resource request message further includes travel information of the UE and/or an RNTI of the UE, and the RNTI is allocated to the UE by the base station when the UE is accessing a cellular network. Optionally, the travel information includes one or more pieces of the following information: vehicle speed information of a vehicle on which the UE is located, or geographical location information and/or a travel direction of a vehicle on which the UE is located. In this embodiment of the present invention, the UE requests the VDC resource mainly for sending a third type of vehicle service information. Certainly, the UE may request the VDC resource for sending other vehicle service information.

Optionally, the UE is connected to a control management system of the vehicle on which the UE is located. The UE may obtain the travel information (for example, the vehicle speed information, brake information, or turning information) of the vehicle from the control management system of the vehicle on which the UE is located. Optionally, the UE may obtain, by using a positioning module (for example, a GPS module) configured on the UE, the geographical location information, the travel direction, or the like of the vehicle on which the UE is located. The UE generates one or more pieces of third type of vehicle service information according to the obtained geographical location information, travel direction, travel information, or the like of the vehicle. Each time the UE generates one piece of third type of vehicle service information, the UE requests a VDC resource from the base station for sending the generated third type of vehicle service information. In this embodiment of the present invention, the UE sends the VDC resource request message to the base station. It should be noted that the third type of vehicle service information in this embodiment of the present invention may be generated with reference to an existing manner for generating a third type of vehicle service information, and details are not described herein.

204. The UE receives a VDC resource allocation indication message from the base station.

The VDC resource allocation indication message indicates a VDC resource allocated to the UE by the base station according to the VDC resource request message.

205. The UE sends the vehicle service information by using a VDC resource indicated by the VDC resource allocation indication message.

It should be noted that the UE in this embodiment of the present invention may be a vehicle-mounted terminal, a handheld terminal, or another terminal that can be connected to a vehicle control management system, and is not limited herein.

It may be learned from the foregoing technical solution of the present invention that, in the present invention, user equipment pre-monitors a VDC resource use status, updates a locally stored VDC resource status list, and when the user equipment needs to send vehicle service information (for example, when the user equipment needs to send a third type of vehicle service information that requires a small transmission delay), requests an idle resource in the VDC resource status list from a base station, and then sends the vehicle service information by using a VDC resource allocated by the base station. In an entire process, no complex link establishment process between the user equipment and the base station is required. Therefore, a vehicle service information transmission delay is effectively reduced. Moreover, experimental research data shows that a transmission delay can be less than 100 milliseconds when vehicle service information is transmitted according to the present invention, that is, a transmission delay requirement of the third type of vehicle service information can be satisfied.

The following further describes a VDC resource request method performed by UE in an embodiment of the present invention. In this embodiment of the present invention, a VDC resource request message carries travel information of a vehicle on which the UE is located. Referring to FIG. 3, the VDC resource request method according to this embodiment of the present invention includes the following steps.

301. Obtain travel information of UE when the UE needs to request a VDC resource for sending vehicle service information.

Optionally, the travel information includes one or more pieces of the following information: vehicle speed information of a vehicle on which the UE is located, or geographical location information and/or a travel direction of a vehicle on which the UE is located.

In this embodiment of the present invention, the UE is connected to a control management system of the vehicle on which the UE is located, and the UE may obtain the vehicle speed information of the vehicle on which the UE is located from the control management system of the vehicle on which the UE is located. In addition, the UE may obtain, by using a positioning module (for example, a GPS module) configured on the UE, the geographical location information, the travel direction, or the like of the vehicle on which the UE is located.

302. Send a VDC resource request message to a base station.

The VDC resource request message includes the travel information of the UE obtained in step 301.

Optionally, the VDC resource request message may further include a VDC resource status list and/or an RNTI of the UE. The RNTI is allocated to the UE by the base station when the UE is accessing a cellular network. An available VDC resource is indicated in the VDC resource status list. Optionally, the UE may locally maintain the VDC resource status list on the UE by monitoring a VDC resource use status. Specifically, for a manner for maintaining a local VDC resource status list by the UE, refer to a description in step 202 in the embodiment shown in FIG. 2. Details are not described herein.

In this embodiment of the present invention, VDC is a vehicle direct communication technology designed based on a physical layer of an LTE system, that is, VDC communication is direct communication between UE and UE. A feature of the VDC communication is as follows: A base station configures an independent VDC resource for each cell, and each UE (for example, a vehicle-mounted terminal or a handheld terminal) may obtain VDC resource parameter information by receiving a configuration message that is broadcast by the base station or by establishing a dedicated link to the base station. The VDC resource parameter information is, for example, total bandwidth of VDC resources within a coverage area of the base station, a time-frequency resource configuration parameter of a channel corresponding to each VDC resource, or a channel identifier (for example, a channel number) of a channel corresponding to a VDC resource that can be used by each UE. When sending a vehicle safety message, the UE needs to use only a VDC resource allocated to the UE by the base station. In addition, the UE needs to receive as many signals on the VDC resource as possible, so as to receive as many vehicle safety messages sent by other neighboring UE as possible. The vehicle safety message includes, for example, emergency brake information of a vehicle, or information prompting a coming vehicle at an opposite side when a vehicle is making a turn. The vehicle safety message is mainly used to avoid vehicle collision.

303. The UE receives a VDC resource allocation indication message from the base station.

The VDC resource allocation indication message indicates a VDC resource allocated to the UE by the base station according to the VDC resource request message.

304. The UE sends the vehicle service information by using a VDC resource indicated by the VDC resource allocation indication message.

It should be noted that the UE in this embodiment of the present invention may be a vehicle-mounted terminal, a handheld terminal, or another terminal that can be connected to a vehicle control management system, and is not limited herein.

It may be learned from the foregoing technical solution of the present invention that, in the present invention, when vehicle service information needs to be sent (for example, when a third type of vehicle service information that requires a small transmission delay needs to be sent), travel information of the UE is obtained, and a VDC resource request message that carries the travel information of the UE is sent to a base station, so that the base station allocates an available VDC resource to the user equipment according to the VDC resource request message. Then, the user equipment sends the vehicle service information by using the VDC resource allocated by the base station. In an entire process, no complex link establishment process between the user equipment and the base station is required. Therefore, a vehicle service information transmission delay is effectively reduced. Moreover, experimental research data shows that a transmission delay can be less than 100 milliseconds when vehicle service information is transmitted according to the present invention, that is, a transmission delay requirement of the third type of vehicle service information can be satisfied.

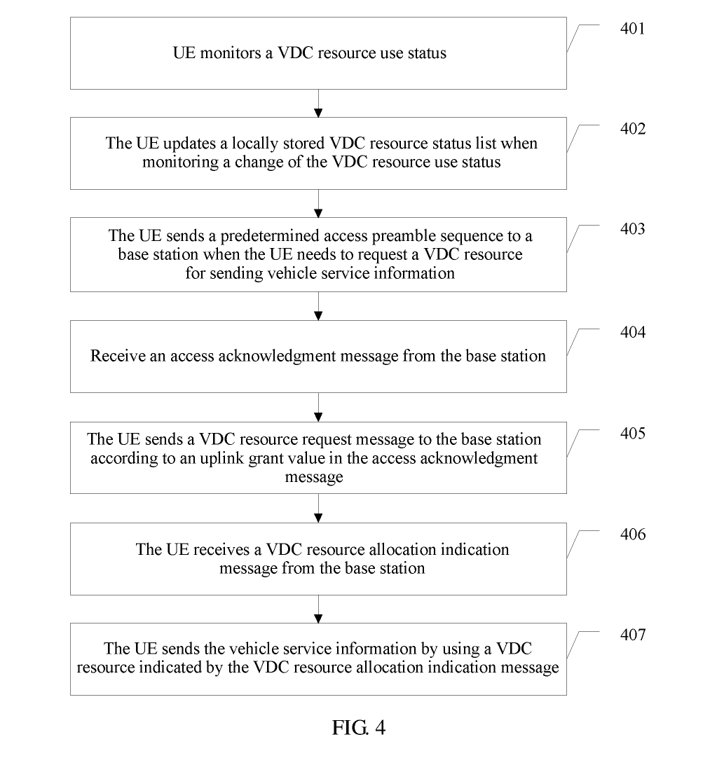

The following further describes a VDC resource request method performed by UE in an embodiment of the present invention. This embodiment of the present invention includes an access request scheme of the UE, and a VDC resource request message carries a VDC resource status list and travel information of a vehicle on which the UE is located. Certainly, based on this embodiment of the present invention and the foregoing embodiments, the VDC resource request message may carry only one of the following: a VDC resource status list, or travel information of a vehicle on which the UE is located. Referring to FIG. 4, the VDC resource request method according to this embodiment of the present invention includes the following steps.

401. UE monitors a VDC resource use status.

Step 401 is similar to step 201 in the embodiment shown in FIG. 2. For a specific implementation manner of step 401, refer to a description in step 201. Details are not described herein.

402. The UE updates a locally stored VDC resource status list when monitoring a change of the VDC resource use status.

An available VDC resource is indicated in the VDC resource status list.

Step 402 is similar to step 202 in the embodiment shown in FIG. 2. For a specific implementation process of step 402, refer to a description in step 202 in the embodiment shown in FIG. 2. Details are not described herein.

403. The UE sends a predetermined access preamble sequence to a base station when the UE needs to request a VDC resource for sending vehicle service information.

A third type of vehicle service information is characterized by burstiness. Therefore, in this embodiment of the present invention, in access timeslot configuration, each subframe within a coverage area of the base station is configured as accessible to the UE. Therefore, the base station needs to notify, by using a broadcast message or by using a dedicated signaling after the UE performs authentication, the UE that the UE can initiate access to all subframes. In addition, a base station side also needs to ensure that the base station side is always prepared for receiving the access preamble sequence (that is, a preamble) from the UE. The base station provides both a cellular network and a VDC service. Therefore, in this embodiment of the present invention, an independent preamble set is preset for requesting a VDC resource by the UE, so that the base station can rapidly process a VDC resource request from the UE. The preamble set includes one or more preambles dedicated for the VDC resource request. When the UE needs to request a VDC resource for sending the vehicle service information, the UE selects a preamble from the preamble set, and sends the preamble to the base station. Specifically, when the UE needs to request a VDC resource for sending the vehicle service information, a Media Access Control (MAC, Media Access Control) layer of the UE selects a preamble from the preamble set, and sends the preamble to a physical layer (that is, a PHY layer) of the UE, and the PHY layer of the UE sends the preamble to the base station in a next nearest subframe.

In this embodiment of the present invention, the UE requests the VDC resource mainly for sending the third type of vehicle service information. Certainly, the UE may request the VDC resource for sending other vehicle service information.

Optionally, the UE is connected to a control management system of a vehicle on which the UE is located. The UE may obtain travel information (for example, vehicle speed information, brake information, or turning information) of the vehicle from the control management system of the vehicle on which the UE is located. Optionally, the UE may obtain, by using a positioning module (for example, a GPS module) configured on the UE, geographical location information, a travel direction, or the like of the vehicle on which the UE is located. The UE generates one or more pieces of third type of vehicle service information according to the obtained geographical location information, travel direction, travel information, or the like of the vehicle. Each time the UE generates one piece of third type of vehicle service information, the UE requests a VDC resource from the base station for sending the generated third type of vehicle service information. In this embodiment of the present invention, the UE sends the predetermined preamble to the base station. It should be noted that the third type of vehicle service information in this embodiment of the present invention may be generated with reference to an existing manner for generating a third type of vehicle service information, and details are not described herein.

404. Receive an access acknowledgment message from the base station.

The access acknowledgment message includes an uplink grant value allocated to the UE by the base station.

In this embodiment of the present invention, when the base station receives the preamble sent by the UE in step 403, and finds that the preamble is a preamble dedicated for requesting a VDC resource by the UE, the base station allocates a large enough uplink grant value (that is, UL grant) to the UE. Generally, geographical location information includes 10 to 20 bytes, and a VDC resource status list is related to a VDC resource quantity. In this embodiment of the present invention, the base station allocates the UL grant to the UE in two manners. A first manner is allocating the UL grant to the UE according to a maximum byte quantity. A second manner is as follows: A quantity of bytes that are sent at the request of the UE is indicated by using the preamble, and the base station allocates, to the UE, a nearest UL grant greater than or equal to the quantity of bytes that are sent at the request of the UE. Optionally, the base station classifies preambles into, for example, three types. A first type of preamble is corresponding to a quantity, less than or equal to 128, of bytes that are sent at request. A second type of preamble is corresponding to a quantity, greater than 128 and less than or equal to 256, of bytes that are sent at request. A third type of preamble is corresponding to a quantity, greater than 256 and less than or equal to 384, of bytes that are sent at request. Specifically, the preambles are not limitedly classified into the foregoing three types, that is, a byte quantity of each type of preamble may be configured according to an actual situation. Further, the base station may broadcast preamble classification information (including byte quantities corresponding to various types of preamble) to the UE by using a broadcast message.

Optionally, after allocating the UL grant to the UE, the base station determines a timing advance (TA, Timing Advance) of the UE, and adds the TA of the UE to the access acknowledgment message, so that the UE adjusts a sending time point according to the TA. Certainly, the base station may not determine a TA of the UE, that is, the access acknowledgment message may not carry the TA of the UE, and the UE adjusts a sending time point according to a downlink TA or an existing TA.

405. The UE sends a VDC resource request message to the base station according to an uplink grant value in the access acknowledgment message.

The VDC resource request message includes the VDC resource status list and the travel information of the UE.

Optionally, the travel information includes one or more pieces of the following information: the vehicle speed information of the vehicle on which the UE is located, or the geographical location information and/or the travel direction of the vehicle on which the UE is located.

In this embodiment of the present invention, the UE is connected to a control management system of the vehicle on which the UE is located, and the UE may obtain the vehicle speed information of the vehicle on which the UE is located from the control management system of the vehicle on which the UE is located. In addition, the UE may obtain, by using a positioning module (for example, a GPS module) configured on the UE, the geographical location information, the travel direction, or the like of the vehicle on which the UE is located.

Optionally, the VDC resource request message further includes an RNTI of the UE, and the RNTI is allocated to the UE by the base station when the UE is accessing a cellular network.

406. The UE receives a VDC resource allocation indication message from the base station.

The VDC resource allocation indication message indicates a VDC resource allocated to the UE by the base station according to the VDC resource request message.

407. The UE sends the vehicle service information by using a VDC resource indicated by the VDC resource allocation indication message.

It should be noted that the UE in this embodiment of the present invention may be a vehicle-mounted terminal, a handheld terminal, or another terminal that can be connected to a vehicle control management system, and is not limited herein.

It may be learned from the foregoing technical solution of the present invention that, in the present invention, user equipment pre-monitors a VDC resource use status, updates a locally stored VDC resource status list, and when the user equipment needs to send vehicle service information (for example, when the user equipment needs to send a third type of vehicle service information that requires a small transmission delay), requests an idle resource in the VDC resource status list from a base station, and then sends the vehicle service information by using a VDC resource allocated by the base station. In an entire process, no complex link establishment process between the user equipment and the base station is required. Therefore, a vehicle service information transmission delay is effectively reduced. Moreover, experimental research data shows that a transmission delay can be less than 100 milliseconds when vehicle service information is transmitted according to the present invention, that is, a transmission delay requirement of the third type of vehicle service information can be satisfied.

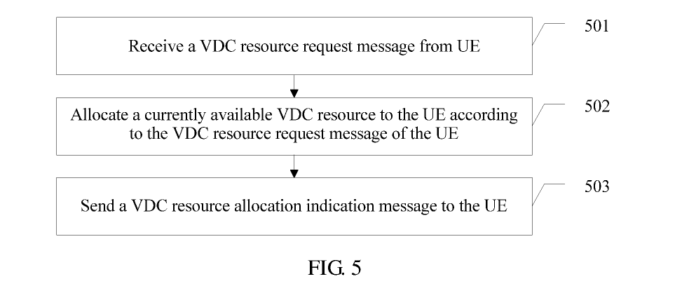

The following describes a VDC resource request method performed by a base station in an embodiment of the present invention. Referring to FIG. 5, the VDC resource request method according to this embodiment of the present invention includes the following steps.

501. Receive a VDC resource request message from UE.

The VDC resource request message includes at least one piece of the following information: a VDC resource status list, or travel information of the UE. An available VDC resource is indicated in the VDC resource status list.

Optionally, the VDC resource request message further includes an RNTI of the UE, and the RNTI is allocated to the UE by the base station when the UE is accessing a cellular network.

Optionally, the travel information includes one or more pieces of the following information: vehicle speed information of a vehicle on which the UE is located, or geographical location information and/or a travel direction of a vehicle on which the UE is located.

In this embodiment of the present invention, VDC is a vehicle direct communication technology designed based on a physical layer of a Long Term Evolution (LTE, Long Term Evolution) system, that is, VDC communication is direct communication between UE and UE. A feature of the VDC communication is as follows: A base station configures an independent VDC resource for each cell, and each UE (for example, a vehicle-mounted terminal or a handheld terminal) may obtain VDC resource parameter information by receiving a configuration message that is broadcast by the base station or by establishing a dedicated link to the base station. The VDC resource parameter information is, for example, total bandwidth of VDC resources within a coverage area of the base station, a time-frequency resource configuration parameter of a channel corresponding to each VDC resource, or a channel identifier (for example, a channel number) of a channel corresponding to a VDC resource that can be used by each UE. When sending a vehicle safety message, the UE needs to use only a VDC resource allocated to the UE by the base station. In addition, the UE needs to receive as many signals on the VDC resource as possible, so as to receive as many vehicle safety messages sent by other neighboring UE as possible. The vehicle safety message includes, for example, emergency brake information of a vehicle, or information prompting a coming vehicle at an opposite side when a vehicle is making a turn. The vehicle safety message is mainly used to avoid vehicle collision.

In an implementation manner of the present invention, if the VDC resource request message carries at least the VDC resource status list, the base station broadcasts VDC resource parameter information on a BCH of a cellular communication resource spectrum. The VDC resource parameter information includes VDC resource bandwidth, VDC resource channel division, and a channel parameter. The channel parameter includes but is not limited to a channel time-domain resource, a channel frequency-domain resource, a channel retransmission moment, a channel modulation and coding scheme, and the like. In this way, all UEs in the coverage area of the base station can obtain the VDC resource parameter information that is broadcast by the base station, and starts to monitor a VDC resource use status in the coverage area of the base station according to the obtained VDC resource parameter information, so as to update a VDC resource status list locally maintained on each UE. Alternatively, in this embodiment of the present invention, the base station may not broadcast VDC resource parameter information. When the UE enters the coverage area of the base station, the UE requests the VDC resource parameter information from the base station, and the base station sends the VDC resource parameter information to the UE after receiving a request of the UE, so that the UE monitors a VDC resource use status, and updates a VDC resource status list locally maintained on the UE.

In another implementation manner of the present invention, if the VDC resource request message carries at least the travel information of the UE, the UE may be connected to a control management system of the vehicle on which the UE is located, and obtain the vehicle speed information of the vehicle on which the UE is located from the control management system of the vehicle on which the UE is located. Optionally, the UE obtains, by using a positioning module (for example, a GPS module) configured on the UE, the geographical location information, the travel direction, or the like of the vehicle on which the UE is located. The travel information further includes the geographical location information and the travel direction that are of the vehicle on which the UE is located.

In this embodiment of the present invention, the UE sends the VDC resource request message to the base station when the UE needs to request a VDC resource for sending vehicle service information.

502. Allocate a currently available VDC resource to the UE according to the VDC resource request message of the UE.

In an implementation manner, if the VDC resource request message carries the VDC resource status list and does not carry the travel information of the UE, the base station selects a VDC resource currently available to the UE from the VDC resource status list according to the VDC resource status list carried in the VDC resource request message, and allocates the VDC resource to the UE.

In another implementation manner, if the VDC resource request message carries the travel information of the UE and does not carry the VDC resource status list, and the travel information includes the vehicle speed information of the vehicle on which the UE is located, the base station allocates a currently available VDC resource to the UE according to the travel information of the UE. Specifically, the base station determines several vehicle speed intervals by means of division, and establishes a correspondence between a vehicle speed interval and a VDC resource. After obtaining the travel information of the UE, the base station may learn the vehicle speed information of the vehicle on which the UE is located, determine a VDC resource range according to a vehicle speed interval of the vehicle speed information of the vehicle on which the UE is located, then select a VDC resource currently available to the UE from the determined VDC resource range for the UE, and allocate the VDC resource to the UE. For example, it is assumed that VDC resources are classified into three types: A first type of VDC resource is corresponding to a vehicle speed interval of 90 kilometers/hour, a second type of VDC resource is corresponding to a vehicle speed interval of 60 kilometers/hour (60 kilometers/hour is not included), and a third type of VDC resource is corresponding to a vehicle speed interval of less than 60 kilometers/hour. It is assumed that a vehicle speed of the vehicle on which the UE is located is 70 kilometers/hour, and the base station learns, by using the VDC resource request message, that the vehicle speed of the vehicle on which the UE is located is 70 kilometers/hour. Because the 70 kilometers/hour is in the vehicle speed interval of 60 kilometers/hour, the base station determines a second type of VDC resource, and selects a VDC resource currently available to the UE from the second type of VDC resource.

Certainly, the VDC resource request message may further carry both the VDC resource status list and the travel information of the UE. The base station allocates a currently available VDC resource to the UE with reference to the foregoing two implementation manners.

Optionally, the base station further interacts VDC resource occupation indication information with a neighboring base station of the base station. The VDC resource occupation indication information is used to indicate occupied VDC resources in respective coverage areas of the base stations. Further, the base station allocates the currently available VDC resource to the UE with reference to the VDC resource request message of the UE and VDC resource occupation indication information of the neighboring base station, so as to avoid collision with a VDC resource within a coverage area of the neighboring base station when the VDC resource is allocated to the UE.

503. Send a VDC resource allocation indication message to the UE.

The VDC resource allocation indication message indicates the VDC resource allocated to the UE by the base station, so that the UE sends the vehicle service information by using the VDC resource indicated by the VDC resource allocation indication message.

A vehicle passes a cell in coverage of a base station in a relatively short time when the vehicle moves at a high speed. If all cells reallocate VDC resources, the VDC resource may be switched for excessively many times in a unit time (for example, one minute). Therefore, the base station expects that a vehicle at a high speed switches a VDC resource for as few times as possible. In addition, a neighboring base station needs to have a same correspondence between a vehicle speed and a VDC resource. Therefore, optionally, in this embodiment of the present invention, the UE adds the travel information of the UE to the VDC resource request message. In addition to the vehicle speed information of the vehicle on which the UE is located, the travel information of the UE further includes the geographical location information and the travel direction that are of the vehicle on which the UE is located. After allocating the available VDC resource to the UE in step 502, the base station further determines, according to the geographical location information and the travel direction that are of the vehicle on which the UE is located, a use range for using the VDC resource by the UE, and the use range refers to duration in which the VDC resource can be used, that is, duration in which the VDC resource can be used after a VDC resource allocation instruction is received; or determines a condition for changing the VDC resource, for example, determines that the vehicle on which the UE is located needs to apply for a resource again after the UE arrives at a particular place. The base station adds, to the VDC resource allocation indication message sent to the UE, the use range of the VDC resource or the condition for changing the VDC resource, so that the UE initiates a VDC resource request to the base station again when a specified time expires or when the vehicle on which the UE is located satisfies the condition for changing the VDC resource (for example, the vehicle on which the UE is located arrives at a designated place).

Optionally, the base station sends the VDC resource allocation indication message to the UE by using a physical downlink shared channel (PDSCH, Physical Downlink Shared Channel).

It should be noted that the UE in this embodiment of the present invention may be a vehicle-mounted terminal, a handheld terminal, or another terminal that can be connected to a vehicle control management system, and is not limited herein.

It may be learned from the foregoing technical solution of the present invention that, in the present invention, after receiving a VDC resource request message of UE, a base station allocates an available VDC resource to the UE according to the resource request message, and indicates the VDC resource to the UE by using a VDC resource allocation indication message, so that the UE sends, according to indication of the VDC resource allocation indication message, vehicle service information by using the VDC resource allocated by the base station. In an entire process, no complex link establishment process between the user equipment and the base station is required. Therefore, a vehicle service information transmission delay is effectively reduced. Moreover, experimental research data shows that a transmission delay can be less than 100 milliseconds when vehicle service information is transmitted according to the present invention, that is, a transmission delay requirement of a third type of vehicle service information can be satisfied.

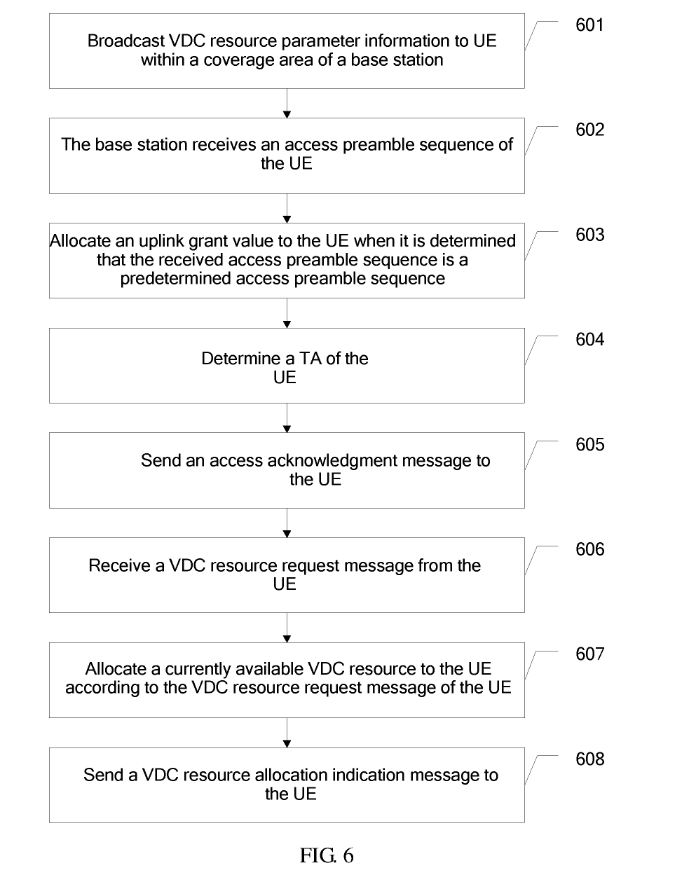

The following further describes a VDC resource request method performed by a base station in an embodiment of the present invention. This embodiment of the present invention includes an access request scheme of UE, and a VDC resource request message carries a VDC resource status list and travel information of a vehicle on which the UE is located. Certainly, based on this embodiment of the present invention and the foregoing embodiments, the VDC resource request message may carry only one of the following: a VDC resource status list, or travel information of a vehicle on which the UE is located. Referring to FIG. 6, the VDC resource request method according to this embodiment of the present invention includes the following steps.

601. Broadcast VDC resource parameter information to UE within a coverage area of a base station.

The VDC resource parameter information includes VDC resource bandwidth, VDC resource channel division, and a channel parameter.

In this embodiment of the present invention, the base station broadcasts the VDC resource parameter information to the UE in the coverage area of the base station on a BCH of a cellular communication resource spectrum. In this way, all UEs in the coverage area of the base station can obtain the VDC resource parameter information that is broadcast by the base station, and starts to monitor a VDC resource use status in the coverage area of the base station according to the obtained VDC resource parameter information, so as to update a VDC resource status list.

602. The base station receives an access preamble sequence of the UE.

A third type of vehicle service information is characterized by burstiness. Therefore, in this embodiment of the present invention, in access timeslot configuration, each subframe in the coverage area of the base station is configured as accessible to the UE. Therefore, the base station needs to notify, by using a broadcast message or by using a dedicated signaling after the UE performs authentication, the UE that the UE can initiate access to all subframes. In addition, a base station side also needs to ensure that the base station side is always prepared for receiving the access preamble sequence (that is, a preamble) from the UE. The base station provides both a cellular network and a VDC service. Therefore, in this embodiment of the present invention, an independent preamble set is preset for requesting a VDC resource by the UE, so that the base station can rapidly process a VDC resource request from the UE. The preamble set includes one or more preambles dedicated for the VDC resource request. When the UE needs to request a VDC resource for sending the vehicle service information, the UE selects a preamble from the preamble set, and sends the preamble to the base station. Specifically, when the UE needs to request a VDC resource for sending the vehicle service information, MAC of the UE selects a preamble from the preamble set, and sends the preamble to a physical layer (that is, a PHY layer) of the UE, and the PHY layer of the UE sends the preamble to the base station in a next nearest subframe.

603. Allocate an uplink grant value to the UE when it is determined that the received access preamble sequence is a predetermined access preamble sequence.

In this embodiment of the present invention, when the base station determines that the received preamble is the predetermined preamble, for example, a preamble in the preamble set, the base station allocates the uplink grant value (that is, UL grant) to the UE.

In this embodiment of the present invention, to ensure that the UE can rapidly return a VDC resource request message, the base station allocates a large enough UL grant to the UE when determining that the received preamble is the predetermined preamble.

Generally, geographical location information includes 10 to 20 bytes, and a VDC resource status list is related to a VDC resource quantity. In this embodiment of the present invention, the base station allocates the UL grant to the UE in two manners. A first manner is allocating the UL grant to the UE according to a maximum byte quantity. A second manner is as follows: A quantity of bytes that are sent at the request of the UE is indicated by using the preamble, and the base station allocates, to the UE, a nearest UL grant greater than or equal to the quantity of bytes that are sent at the request of the UE. Optionally, the base station classifies preambles into, for example, three types. A first type of preamble is corresponding to a quantity, less than or equal to 128, of bytes that are sent at request. A second type of preamble is corresponding to a quantity, greater than 128 and less than or equal to 256, of bytes that are sent at request. A third type of preamble is corresponding to a quantity, between 256 and 384, of bytes that are sent at request. Specifically, the preambles are not limitedly classified into the foregoing three types, that is, a byte quantity of each type of preamble may be configured according to an actual situation. Further, the base station may broadcast preamble classification information (including byte quantities corresponding to various types of preamble) to the UE by using a broadcast message.

604. Determine a TA of the UE.

For determining of the TA of the UE by the base station, refer to an existing solution. Details are not described herein.

605. Send an access acknowledgment message to the UE.

The access acknowledgment message includes the TA of the UE and the uplink grant value allocated to the UE by the base station. Therefore, after adjusting a sending time point according to the TA in the access acknowledgment message, the UE sends the VDC resource request message to the base station according to the uplink grant value in the access acknowledgment message.

606. Receive a VDC resource request message from the UE.

Step 606 is similar to step 501 in the embodiment shown in FIG. 5. For a specific implementation manner of step 606, refer to a description in step 501. Details are not described herein.

607. Allocate a currently available VDC resource to the UE according to the VDC resource request message of the UE.

The base station allocates the currently available VDC resource to the UE according to the VDC resource status list and travel information of the UE that are carried in the VDC resource request message of the UE.

Optionally, the base station further interacts VDC resource occupation indication information with a neighboring base station of the base station. The VDC resource occupation indication information is used to indicate occupied VDC resources in respective coverage areas of the base stations. Further, the base station allocates the currently available VDC resource to the UE with reference to the VDC resource request message of the UE and VDC resource occupation indication information of the neighboring base station, so as to avoid collision with a VDC resource within a coverage area of the neighboring base station when the VDC resource is allocated to the UE.

Optionally, when the base station interacts VDC resource occupation information with the neighboring base station, travel direction information of a corresponding vehicle during use of each VDC resource is further carried, so that a base station that receives the VDC resource occupation information can determine whether the occupied VDC resource can be used within a coverage area of the base station without causing resource collision in a period of time after the VDC resource occupation information is received. For example, if VDC resource occupation information sent by a base station a to a base station b indicates that a VDC resource 1 is occupied and a travel direction is travel away from the base station b, after a period of time (for example, one second after the VDC resource occupation information is received) after the VDC resource occupation information is received, the base station b may allocate the VDC resource 1 to UE that is in a direction away from the base station a and just enters a coverage area of the base station b.

608. Send a VDC resource allocation indication message to the UE.

The VDC resource allocation indication message indicates the VDC resource allocated to the UE by the base station, so that the UE sends the vehicle service information by using the VDC resource indicated by the VDC resource allocation indication message.

A vehicle passes a cell in coverage of a base station in a relatively short time when the vehicle moves at a high speed. If all cells reallocate VDC resources, the VDC resource may be switched for excessively many times in a unit time (for example, one minute). Therefore, the base station expects that a vehicle at a high speed switches a VDC resource for as few times as possible. Therefore, optionally, in this embodiment of the present invention, the UE adds the travel information of the UE to the VDC resource request message. In addition to vehicle speed information of a vehicle on which the UE is located, the travel information of the UE further includes the geographical location information and the travel direction that are of the vehicle on which the UE is located. After allocating the available VDC resource to the UE in step 607, the base station further determines, according to the geographical location information and the travel direction that are of the vehicle on which the UE is located, a use range for using the VDC resource by the UE, and the use range refers to duration in which the VDC resource can be used, that is, duration in which the VDC resource can be used after a VDC resource allocation instruction is received; or determines a condition for changing the VDC resource, for example, determines that the vehicle on which the UE is located needs to apply for a resource again after the UE arrives at a particular place. The base station adds, to the VDC resource allocation indication message sent to the UE, the use range of the VDC resource or the condition for changing the VDC resource, so that the UE initiates a VDC resource request to the base station again when a specified time expires or when the vehicle on which the UE is located satisfies the condition for changing the VDC resource (for example, the vehicle on which the UE is located arrives at a designated place).

Optionally, the base station sends the VDC resource allocation indication message to the UE by using a PDSCH.

It should be noted that, in an example of this embodiment of the present invention, the VDC resource request message carries the VDC resource status list and the travel information of the vehicle on which the UE is located. If the VDC resource request message does not carry the VDC resource status list, step 601 in this embodiment of the present invention may be omitted. In addition, step 604 in this embodiment of the present invention may also be omitted. That is, the base station may not determine a TA of the UE, and the access acknowledgment message sent in step 605 does not carry the TA of the UE. The UE may adjust a sending time point according to a downlink TA or an existing TA.

It should be noted that the UE in this embodiment of the present invention may be a vehicle-mounted terminal, a handheld terminal, or another terminal that can be connected to a vehicle control management system, and is not limited herein.

It may be learned from the foregoing technical solution of the present invention that, in the present invention, after receiving a VDC resource request message of UE, a base station allocates an available VDC resource to the UE according to the resource request message, and indicates the VDC resource to the UE by using a VDC resource allocation indication message, so that the UE sends, according to indication of the VDC resource allocation indication message, vehicle service information by using the VDC resource allocated by the base station. In an entire process, no complex link establishment process between the user equipment and the base station is required. Therefore, a vehicle service information transmission delay is effectively reduced. Moreover, experimental research data shows that a transmission delay can be less than 100 milliseconds when vehicle service information is transmitted according to the present invention, that is, a transmission delay requirement of a third type of vehicle service information can be satisfied.

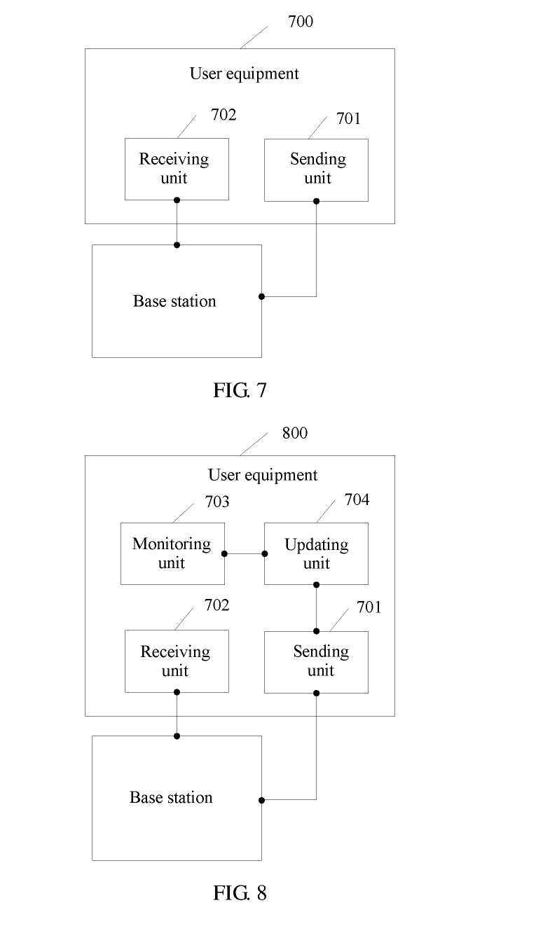

An embodiment of the present invention further provides user equipment. As shown in FIG. 7, user equipment 700 in this embodiment of the present invention includes a sending unit 701, configured to send a VDC resource request message to a base station when the user equipment 700 needs to request a VDC resource for sending vehicle service information, where the VDC resource request message includes at least one piece of the following information: a VDC resource status list, or travel information of the user equipment 700, and an available VDC resource is indicated in the VDC resource status list. Optionally, the travel information includes one or more pieces of the following information: vehicle speed information of a vehicle on which the user equipment 700 is located, or geographical location information and a travel direction of a vehicle on which the user equipment 700 is located; and optionally, the VDC resource request message further includes an RNTI of the UE, and the RNTI is allocated to the UE by the base station when the UE is accessing a cellular network, and a receiving unit 702, configured to receive a VDC resource allocation indication message from the base station, where the VDC resource allocation indication message indicates a VDC resource allocated to the user equipment 700 by the base station according to the VDC resource request message.

The sending unit 702 is further configured to send the vehicle service information by using the VDC resource indicated by the VDC resource allocation indication message.

In an application scenario, the VDC resource request message includes the VDC resource status list. Optionally, based on the embodiment shown in FIG. 7, as shown in FIG. 8, user equipment 800 further includes: a monitoring unit 703, configured to monitor a VDC resource use status; and an updating unit 704, configured to update a locally stored VDC resource status list when the monitoring unit 703 monitors a change of the VDC resource use status.

Optionally, the monitoring unit 703 includes: an obtaining unit, configured to obtain VDC resource parameter information that is broadcast by the base station, where the VDC resource parameter information includes VDC resource bandwidth, VDC resource channel division, and a channel parameter; and a monitoring subunit, configured to monitor the VDC resource use status according to the VDC resource parameter information obtained by the obtaining unit.

Optionally, the sending unit 701 is further configured to send a predetermined access preamble sequence to the base station before sending the VDC resource request message to the base station, so that the base station learns, according to the predetermined access preamble sequence, that the user equipment currently needs to apply for a VDC resource, and allocates an uplink grant value to the user equipment. The receiving unit 702 is further configured to receive an access acknowledgment message from the base station, and the access acknowledgment message includes the uplink grant value allocated to the user equipment by the base station. The sending unit 701 is configured to send the VDC resource request message to the base station according to the uplink grant value in the access acknowledgment message. Optionally, after allocating the uplink grant value to the UE, the base station determines a TA of the UE, and adds the TA of the UE to the access acknowledgment message, so that the UE adjusts a sending time point according to the TA.

It should be noted that, in this embodiment of the present invention, VDC is a vehicle direct communication technology designed based on a physical layer of an LTE system, that is, VDC communication is direct communication between UE and UE. A feature of the VDC communication is as follows: A base station configures an independent VDC resource for each cell, and each user equipment (for example, a vehicle-mounted terminal or a handheld terminal) may obtain VDC resource parameter information by receiving a configuration message that is broadcast by the base station or by establishing a dedicated link to the base station. The VDC resource parameter information is, for example, total bandwidth of VDC resources within a coverage area of the base station, a time-frequency resource configuration parameter of a channel corresponding to each VDC resource, or a channel identifier (for example, a channel number) of a channel corresponding to a VDC resource that can be used by each UE. When sending a vehicle safety message, the user equipment needs to use only a VDC resource allocated to the UE by the base station. In addition, the user equipment needs to receive as many signals on the VDC resource as possible, so as to receive as many vehicle safety messages sent by other neighboring UE as possible. The vehicle safety message includes, for example, emergency brake information of a vehicle, or information prompting a coming vehicle at an opposite side when a vehicle is making a turn. The vehicle safety message is mainly used to avoid vehicle collision.

It should be noted that the user equipment in this embodiment of the present invention may be a vehicle-mounted terminal, a handheld terminal, or another terminal that can be connected to a vehicle control management system, and is not limited herein. The user equipment in this embodiment of the present invention may be the user equipment in the foregoing method embodiments, and may be configured to implement all technical solutions in the foregoing method embodiments. Functions of each function module of the user equipment may be implemented according to the methods described in the foregoing method embodiments. For a specific implementation process, refer to the related descriptions in the foregoing embodiments. Details are not described herein.

It may be learned from the foregoing technical solution of the present invention that, in the present invention, user equipment sends a VDC resource request message to a base station when the user equipment needs to send vehicle service information (for example, when the user equipment needs to send a third type of vehicle service information that requires a small transmission delay), so that the base station allocates an available VDC resource to the user equipment according to the VDC resource request message. Then, the user equipment sends the vehicle service information by using the VDC resource allocated by the base station. In an entire process, no complex link establishment process between the user equipment and the base station is required. Therefore, a vehicle service information transmission delay is effectively reduced. Moreover, experimental research data shows that a transmission delay can be less than 100 milliseconds when vehicle service information is transmitted according to the present invention, that is, a transmission delay requirement of the third type of vehicle service information can be satisfied.

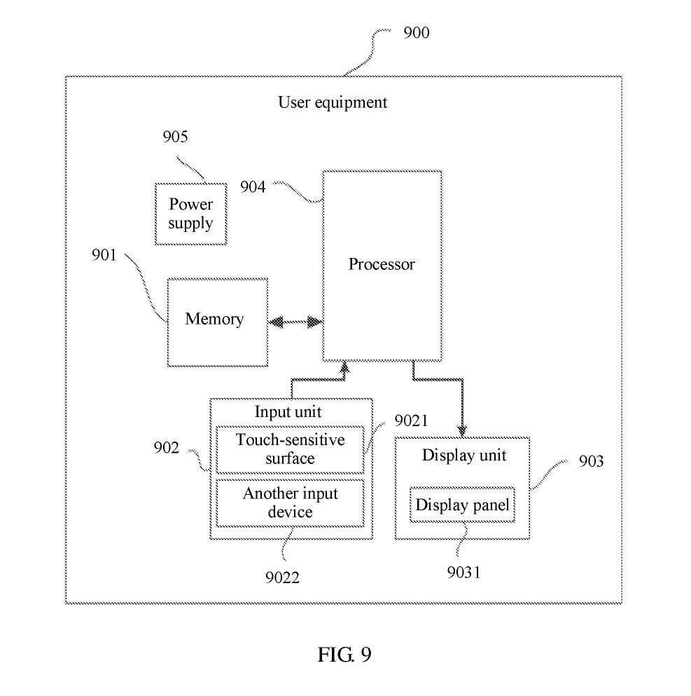

An embodiment of the present invention provides another type of user equipment. The following describes the user equipment in this embodiment of the present invention. As shown in FIG. 9, user equipment 900 in this embodiment of the present invention includes parts such as a memory 901 of one or more computer-readable storage media, an input unit 902, a display unit 903, a processor 904 of one or more processing cores, and a power supply 905. Persons killed in the art may understand that a user equipment structure shown in FIG. 9 does not limit the user equipment, parts more or less than those shown in the figure may be included, some parts may be combined, or a different part configuration may be included.

The memory 901 may be configured to store a software program and a module, and the processor 904 executes various functional applications and data processing by running the software program and the module that are stored in the memory 901. The memory 901 may mainly include a program storage area and a data storage area. The program storage area may store an operating system, an application program required by at least one function (such as a sound play function or an image play function), and the like. The data storage area may store data (such as audio data or vehicle travel information) created according to use of the user equipment 900, and the like. In addition, the memory 901 may include a high-speed random access memory, and may further include a non-volatile memory, for example, at least one magnetic disk storage component, a flash memory component, or another volatile solid-state storage component. Correspondingly, the memory 901 may further include a memory controller, so as to provide the processor 904 and the input unit 902 with access to the memory 901.

The input unit 902 may be configured to: receive input digits or character information, and generate keyboard, mouse, joystick, optics, or trackball signal input related to user setting and function control. The input unit 902 may be represented by a receiver. Optionally, the input unit 902 includes a touch-sensitive surface 9021 and another input device 9022. The touch-sensitive surface 9021, also referred to as a touchscreen or a touch panel, may collect a touch operation (such as an operation performed by a user on the touch-sensitive surface 9021 or near the touch-sensitive surface 9021 by using a finger, a stylus, or any another suitable object or accessory) of a user on or near the touch-sensitive surface, and drives a corresponding connection apparatus according to a preset program. Optionally, the touch-sensitive surface 9021 may include two parts: a touch detection apparatus and a touch controller. The touch detection apparatus detects a touch location of a user, detects a signal brought by a touch operation, and sends the signal to the touch controller. The touch controller receives touch information from the touch detection apparatus, converts the touch information into touch coordinates, and sends the touch coordinates to the processor 904, and can receive and execute a command sent by the processor 904. In addition, the touch-sensitive surface 9021 may be implemented in multiple types, such as resistance-type, capacitor-type, infrared ray, and surface acoustic wave. In addition to the touch-sensitive surface 9021, the input unit 902 may include another input device 9022. Specifically, the another input device 9022 may include but is not limited to one or more of a physical keyboard, a function key (such as a volume control key or an on/off key), a trackball, a mouse, a joystick, or the like.

The display unit 903 may be configured to display information input by a user, or information provided for a user, and various graphic user interfaces of the terminal 900. The graphic user interfaces may include a graphic, a text, an icon, a video, and any combination thereof. The display unit 903 may include a display panel 9031. Optionally, the display panel 9031 may be configured in a form such as a liquid crystal display (LCD), or an organic light-emitting diode (OLED). Further, the touch-sensitive surface 9021 may cover the display panel 9031. When detecting the touch operation on or near the touch-sensitive surface 9021, the touch-sensitive surface 9021 transmits the touch operation to the processor 904 to determine a type of a touch event, and then the processor 904 provides corresponding visual output on the display panel 9031 according to the type of the touch event. In FIG. 9, the touch-sensitive surface 9021 and the display panel 9031 are used as two independent parts to implement input and output functions. However, in some embodiments, the touch-sensitive surface 9021 and the display panel 9031 may be integrated to implement the input and output functions.

The processor 904 is a control center of the user equipment 900, connects all parts of the entire mobile phone by using various interfaces and lines, executes, by running or executing the software program and/or the module stored in the memory 901 and by invoking data stored in the memory 901, various functions of the user equipment 900, and processes the data, so as to perform overall monitoring on the user equipment 900. Optionally, the processor 904 may include one or more processing cores. Preferably, an application processor and a modem processor may be integrated into the processor 904. The application processor mainly processes an operating system, a user interface, an application program, and the like, and the modem processor mainly processes wireless communications. Certainly, the modem processor may not be integrated into the processor 904.

The user equipment 900 further includes the power supply 905 (for example, a battery) that supplies power to each part. Preferably, the power supply may be logically connected to the processor 904 by using a power supply management system, so as to manage charging, discharging, and power consumption by using the power supply management system. The power supply 905 may include one or more direct current or alternating current power supplies, a rechargeable system, a power failure detection circuit, a power converter or an inverter, a power status indicator, or any another component.

Although not shown, the user equipment 900 may further include a transmitter (such as a radio frequency (RF, Radio Frequency) circuit), a sensor, an audio frequency circuit, a wireless fidelity (WiFi, wireless fidelity) module, a camera, a Bluetooth module, and the like. Details are not described herein. Specifically, in this embodiment, the user equipment 900 further includes one or more programs that are stored in the memory 901 and configured to be executed by one or more processors 904. The one or more programs include an instruction used to perform the following operations.

A VDC resource request message is sent to a base station when the user equipment 900 needs to request a VDC resource for sending vehicle service information. The VDC resource request message includes at least one piece of the following information: the VDC resource status list, or travel information of the user equipment 900, and an available VDC resource is indicated in the VDC resource status list. Optionally, the travel information includes at least one piece of the following information: vehicle speed information of a vehicle on which the user equipment 900 is located, or geographical location information and a travel direction of a vehicle on which the user equipment 700 is located.

A VDC resource allocation indication message from the base station is received. The VDC resource allocation indication message indicates a VDC resource allocated to the user equipment 900 by the base station according to the VDC resource request message.

The vehicle service information is sent by using the VDC resource indicated by the VDC resource allocation indication message.

It is assumed that the foregoing description is a first possible implementation manner. In a second possible implementation manner provided based on the first possible implementation manner, the VDC resource request message includes the VDC resource status list, and the processor 904 is further configured to perform the following instructions: monitoring a VDC resource use status, and when a change of the VDC resource use status is monitored, updating the VDC resource status list stored in the memory 901.

In a third possible implementation manner provided based on the second possible implementation manner, the monitoring a VDC resource use status includes: VDC resource parameter information that is broadcast by the base station is obtained, where the VDC resource parameter information includes VDC resource bandwidth, VDC resource channel division, and a channel parameter; and the VDC resource use status is monitored according to the obtained VDC resource parameter information.

In a fourth possible implementation manner provided based on the first possible implementation manner, the second possible implementation manner, or the third possible implementation manner, before sending the VDC resource request message, the user equipment 900 sends a predetermined access preamble sequence to the base station, so that the base station learns, according to the predetermined access preamble sequence, that the user equipment 900 currently needs to apply for a VDC resource, and allocates an uplink grant value to the user equipment 900; and receives an access acknowledgment message from the base station. The access acknowledgment message includes the uplink grant value allocated to the user equipment 900 by the base station.

The sending a VDC resource request message to a base station is where the VDC resource request message is sent to the base station according to the uplink grant value in the access acknowledgment message.

It should be noted that the user equipment in this embodiment of the present invention may be a vehicle-mounted terminal, a handheld terminal, or another terminal that can be connected to a vehicle control management system, and is not limited herein. The user equipment in this embodiment of the present invention may be the user equipment in the foregoing method embodiments, and may be configured to implement all technical solutions in the foregoing method embodiments. Functions of each function module of the user equipment may be implemented according to the methods described in the foregoing method embodiments. For a specific implementation process, refer to the related descriptions in the foregoing embodiments. Details are not described herein.

It may be learned from the foregoing technical solution of the present invention that, in the present invention, user equipment sends a VDC resource request message to a base station when the user equipment needs to send vehicle service information (for example, when the user equipment needs to send a third type of vehicle service information that requires a small transmission delay), so that the base station allocates an available VDC resource to the user equipment according to the VDC resource request message. Then, the user equipment sends the vehicle service information by using the VDC resource allocated by the base station. In an entire process, no complex link establishment process between the user equipment and the base station is required. Therefore, a vehicle service information transmission delay is effectively reduced. Moreover, experimental research data shows that a transmission delay can be less than 100 milliseconds when vehicle service information is transmitted according to the present invention, that is, a transmission delay requirement of the third type of vehicle service information can be satisfied.

An embodiment of the present invention further provides a base station. As shown in FIG. 10, a base station 1000 in this embodiment of the present invention includes: a first receiving unit 1001, configured to receive a VDC resource request message from user equipment, where the VDC resource request message includes at least one piece of the following information: a VDC resource status list, or travel information of the user equipment, and an available VDC resource is indicated in the VDC resource status list; and optionally, the travel information includes at least one piece of the following information: vehicle speed information of a vehicle on which the user equipment 700 is located, or geographical location information and a travel direction of a vehicle on which the user equipment 700 is located, a first allocation unit 1002, configured to allocate a currently available VDC resource to the user equipment according to the VDC resource request message of the user equipment received by the first receiving unit 1001, and a first sending unit 1003, configured to send a VDC resource allocation indication message to the user equipment, where the VDC resource allocation indication message indicates the VDC resource allocated to the user equipment by the first allocation unit 1002, so that the user equipment sends vehicle service information by using the VDC resource indicated by the VDC resource allocation indication message.

Optionally, based on the embodiment shown in FIG. 10, the VDC resource request message includes the VDC resource status list. The base station in this embodiment of the present invention further includes a broadcasting unit, configured to broadcast VDC resource parameter information to user equipment within a coverage area of the base station. The VDC resource parameter information includes VDC resource bandwidth, VDC resource channel division, and a channel parameter.

Optionally, the VDC resource request message includes the travel information of the user equipment, and the travel information includes the vehicle speed information of the vehicle on which the user equipment is located. The first allocation unit 1002 is configured to: determine a VDC resource range according to a vehicle speed interval of the vehicle speed information of the vehicle on which the user equipment is located, and allocate the currently available VDC resource in the determined VDC resource range to the user equipment. There is a correspondence between the vehicle speed interval and the VDC resource range.

Optionally, the base station in this embodiment of the present invention further includes a second receiving unit, configured to receive VDC resource occupation indication information from a neighboring base station, where the VDC resource occupation indication information of the neighboring base station is used to indicate an occupied VDC resource within a coverage area of the neighboring base station. The first allocation unit 1002 is configured to allocate the currently available VDC resource to the user equipment according to the VDC resource request message of the user equipment and the VDC resource occupation indication information of the neighboring base station.

Optionally, the base station in this embodiment of the present invention further includes: a third receiving unit, configured to receive an access preamble sequence of the user equipment; a second allocation unit, configured to allocate an uplink grant value to the user equipment when it is determined that the access preamble sequence is a predetermined access preamble sequence; a determining unit, configured to determine a time advance of the user equipment; and a second sending unit, configured to send an access acknowledgment message to the user equipment, where the access acknowledgment message includes the time advance of the user equipment and the uplink grant value allocated to the user equipment by the base station.

Optionally, the access preamble sequence of the user equipment is further used to indicate a quantity of bytes that are sent at the request of the user equipment. The second allocation unit is configured to allocate, to the user equipment according to the access preamble sequence of the user equipment received by the third receiving unit, an uplink grant value greater than or equal to the quantity of bytes that are sent at the request of the user equipment.

It should be noted that the base station in this embodiment of the present invention may be the base station in the foregoing method embodiments, and may be configured to implement all technical solutions in the foregoing method embodiments. Functions of each function module may be implemented according to the methods in the foregoing method embodiments. For a specific implementation process, refer to the related descriptions in the foregoing embodiments. Details are not described herein.

It may be learned from the foregoing technical solution of the present invention that, in the present invention, after receiving a VDC resource request message of user equipment, a base station allocates an available VDC resource to the user equipment according to the resource request message, and indicates the VDC resource to the user equipment by using a VDC resource allocation indication message, so that the user equipment sends, according to indication of the VDC resource allocation indication message, vehicle service information by using the VDC resource allocated by the base station. In an entire process, no complex link establishment process between the user equipment and the base station is required. Therefore, a vehicle service information transmission delay is effectively reduced. Moreover, experimental research data shows that a transmission delay can be less than 100 milliseconds when vehicle service information is transmitted according to the present invention, that is, a transmission delay requirement of a third type of vehicle service information can be satisfied.

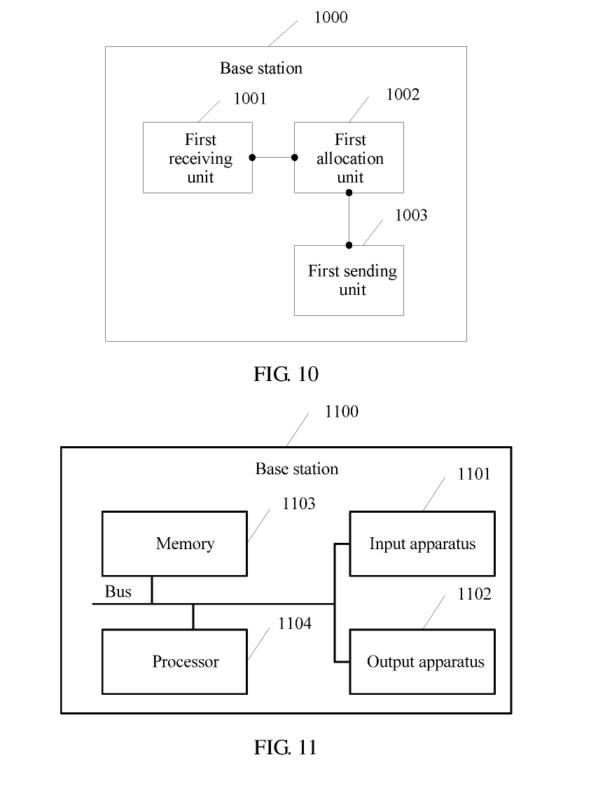

The following describes another base station in an embodiment of the present invention. Referring to FIG. 11, a base station 1100 in this embodiment of the present invention includes an input apparatus 1101 (for example, a receiver), an output apparatus 1102 (for example, a transmitter), a memory 1103, and a processor 1104 (the base station 1100 may include one or more processors 1104, and one processor is used as an example in FIG. 11). In some embodiments of the present invention, the input apparatus 1101, the output apparatus 1102, the memory 1103, and the processor 1104 may be connected by using a bus or in another manner, and connection by using a bus is used as an example in FIG. 11. The memory 1103 is configured to store data input by the input apparatus 1101, and may further store information such as essential files used in data processing of the processor 1104. The input apparatus 1101 and the output apparatus 1102 may include a port used for communication between the base station 1100 and another device. In this embodiment, the port that is used for communication with another device and that is between the input apparatus 1101 and the output apparatus 1102 may be an antenna and/or a cable.

The processor 1104 performs the steps of receiving a VDC resource request message from UE, where the VDC resource request message includes at least one piece of the following information: a VDC resource status list, or travel information of the UE, and an available VDC resource is indicated in the VDC resource status list; and optionally, the travel information includes at least one piece of the following information: vehicle speed information of a vehicle on which the UE is located, or geographical location information and a travel direction of a vehicle on which the UE is located, allocating a currently available VDC resource to the UE according to the VDC resource request message of the UE, and sending a VDC resource allocation indication message to the UE, where the VDC resource allocation indication message indicates the VDC resource allocated to the UE by the processor 1104, so that the UE sends vehicle service information by using the VDC resource indicated by the VDC resource allocation indication message.

It should be noted that the base station in this embodiment of the present invention may be the base station in the foregoing method embodiments, and may be configured to implement all technical solutions in the foregoing method embodiments. Functions of each function module may be implemented according to the methods in the foregoing method embodiments. For a specific implementation process, refer to the related descriptions in the foregoing embodiments. Details are not described herein.

It may be learned from the foregoing that, after receiving a VDC resource request message of user equipment, a base station allocates an available VDC resource to the user equipment according to the resource request message, and indicates the VDC resource to the user equipment by using a VDC resource allocation indication message, so that the user equipment sends, according to indication of the VDC resource allocation indication message, vehicle service information by using the VDC resource allocated by the base station. In an entire process, no complex link establishment process between the user equipment and the base station is required. Therefore, a vehicle service information transmission delay is effectively reduced. Moreover, experimental research data shows that a transmission delay can be less than 100 milliseconds when vehicle service information is transmitted according to the present invention, that is, a transmission delay requirement of a third type of vehicle service information can be satisfied.

In the several embodiments provided in the present application, it should be understood that the disclosed apparatus and method may be implemented in other manners. For example, the described apparatus embodiment is merely an example. For example, the unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate parts may or may not be physically separate, and parts displayed as units may or may not be physical units, that is, may be located in one position, or may be distributed on multiple network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or some of the technical solutions may be implemented in the form of a software product. The software product is stored in a storage medium and includes several instructions for instructing a computer device (which may be a personal computer, a server, a network device, or the like) to perform all or some of the steps of the methods described in the embodiments of the present invention. The foregoing storage medium includes: any medium that can store program code, such as a USB flash drive, a removable hard disk, a read-only memory (ROM), a random access memory (RAM), a magnetic disk, or an optical disc.

It should be noted that, for a brief description, the foregoing method embodiments are represented as a series of actions. However, persons skilled in the art should appreciate that the present invention is not limited to the described order of the actions, because according to the present invention, some steps may be performed in another order or simultaneously. In addition, persons skilled in the art should also understand that the embodiments described in this specification are examples, and the involved actions and modules are not necessarily mandatory to the present invention.

In the foregoing embodiments, the description of each embodiment has respective focuses. For a part that is not described in detail in an embodiment, refer to related descriptions in other embodiments.

A VDC resource request method, user equipment, and a base station that are provided in the present invention are described above, and persons of ordinary skill in the art may make modifications to a specific implementation manner and an application scope according to the idea of the present invention. In conclusion, content of this specification should not be understood as a limitation to the present invention.

What is claimed is:

1. A vehicle direct communication (VDC) resource request method, comprising:
sending, by user equipment, a VDC resource request message to a base station when the user equipment needs to request a VDC resource for sending vehicle service information, wherein the VDC resource request message comprises at least one of a VDC resource status list, or travel information of the user equipment, and wherein an available VDC resource is indicated in the VDC resource status list;
receiving, by the user equipment, a VDC resource allocation indication message from the base station, wherein the VDC resource allocation indication message indicates a VDC resource allocated to the user equipment by the base station according to the VDC resource request message; and
sending, by the user equipment, the vehicle service information by using the VDC resource indicated by the VDC resource allocation indication message.

2. The method according to claim 1, wherein the VDC resource request message comprises the VDC resource status list; and
wherein the method further comprises:
monitoring, by the user equipment, a VDC resource use status; and
updating, by the user equipment, a locally stored VDC resource status list in response to detecting a change of the VDC resource use status.

3. The method according to claim 2, wherein the monitoring, by the user equipment, the VDC resource use status comprises:
obtaining VDC resource parameter information that is broadcast by the base station, wherein the VDC resource parameter information comprises VDC resource bandwidth, VDC resource channel division, and a channel parameter; and
monitoring the VDC resource use status according to the obtained VDC resource parameter information.

4. The method according to claim 1, wherein the method further comprises performing, before the sending, by the user equipment, the VDC resource request message to the base station:
sending, by the user equipment, a predetermined access preamble sequence to the base station, so that the base station learns, according to the predetermined access preamble sequence, that the user equipment currently needs to apply for a VDC resource, and allocates an uplink grant value to the user equipment; and
receiving an access acknowledgment message from the base station, wherein the access acknowledgment message comprises the uplink grant value allocated to the user equipment by the base station; and
wherein the sending, by the user equipment, the VDC resource request message to a base station comprises sending, by the user equipment, the VDC resource request message to the base station according to the uplink grant value in the access acknowledgment message.

5. A user equipment, comprising:
a transmitter;
a receiver;
a processor; and
a non-transitory computer-readable storage medium storing a program to be executed by the processor, the program including instructions to:
control the transmitter to send a vehicle direct communication (VDC) resource request message to a base station when the user equipment needs to request a VDC resource for sending vehicle service information, wherein the VDC resource request message comprises at least one of: a VDC resource status list, or travel information of the user equipment, and wherein an available VDC resource is indicated in the VDC resource status list, wherein the receiver is configured to receive a VDC resource allocation indication message from the base station, wherein the VDC resource allocation indication message indicates a VDC resource allocated to the user equipment by the base station according to the VDC resource request message; and
control the transmitter to send the vehicle service information by using the VDC resource indicated by the VDC resource allocation indication message.

6. The user equipment according to claim 5, wherein the VDC resource request message comprises the VDC resource status list; and
wherein the program further includes instructions to monitor a VDC resource use status, and update a locally stored VDC resource status list when monitoring a change of the VDC resource use status.

7. The user equipment according to claim 6, wherein the program further includes instructions to:
obtain VDC resource parameter information that is broadcast by the base station, wherein the VDC resource parameter information comprises VDC resource bandwidth, VDC resource channel division, and a channel parameter; and
monitor the VDC resource use status according to the VDC resource parameter information.

8. The user equipment according to claim 5, wherein the program further includes instructions to control the transmitter to send a predetermined access preamble sequence to the base station before sending the VDC resource request message to the base station, so that the base station learns, according to the predetermined access preamble sequence, that the user equipment currently needs to apply for a VDC resource, and allocates an uplink grant value to the user equipment;
wherein the receiver is further configured to receive an access acknowledgment message from the base station, and the access acknowledgment message comprises the uplink grant value allocated to the user equipment by the base station; and
wherein the program further includes instructions to control the transmitter to send the VDC resource request message to the base station according to the uplink grant value in the access acknowledgment message.

9. A base station, comprising:
a transmitter;
a receiver, configured to receive a vehicle direct communication (VDC) resource request message from user equipment, wherein the VDC resource request message comprises at least one of a VDC resource status list, or travel information of the user equipment, and wherein an available VDC resource is indicated in the VDC resource status list;
a processor; and
a non-transitory computer-readable storage medium storing a program to be executed by the processor, the program including instructions to:
allocate a currently available VDC resource to the user equipment according to the VDC resource request message of the user equipment received by the receiver; and
control the transmitter to send a VDC resource allocation indication message to the user equipment, wherein the VDC resource allocation indication message indicates the VDC resource allocated to the user equipment by the base station, so that the user equipment sends vehicle service information by using the VDC resource indicated by the VDC resource allocation indication message.

10. The base station according to claim 9, wherein the VDC resource request message comprises the VDC resource status list; and
wherein the program further includes instructions to broadcast VDC resource parameter information to user equipment within a coverage area of the base station, wherein the VDC resource parameter information comprises VDC resource bandwidth, VDC resource channel division, and a channel parameter.

11. The base station according to claim 9, wherein the VDC resource request message comprises the travel information of the user equipment, and the travel information comprises vehicle speed information of a vehicle on which the user equipment is located; and
wherein the program further includes instructions to determine a VDC resource range according to a vehicle speed interval of the vehicle speed information of the vehicle on which the user equipment is located, and allocate the currently available VDC resource in the determined VDC resource range to the user equipment, wherein there is a correspondence between the vehicle speed interval and the VDC resource range.

12. The base station according to claim 9, wherein the receiver is further configured to receive VDC resource occupation indication information from a neighboring base station, wherein the VDC resource occupation indication information of the neighboring base station indicates an occupied VDC resource within a coverage area of the neighboring base station; and
wherein the program further includes instructions to allocate the currently available VDC resource to the user equipment according to the VDC resource request message of the user equipment and the VDC resource occupation indication information of the neighboring base station.

13. The base station according to claim 9, wherein
the receiver is further configured to receive an access preamble sequence of the user equipment; and
wherein the program further includes instructions to
allocate an uplink grant value to the user equipment when it is determined that the access preamble sequence is a predetermined access preamble sequence, determine a time advance of the user equipment; and
control the transmitter to send an access acknowledgment message to the user equipment, wherein the access acknowledgment message comprises the time advance of the user equipment and the uplink grant value allocated to the user equipment by the base station.

14. The base station according to claim 13, wherein the access preamble sequence of the user equipment is further indicates a quantity of bytes that are sent at the request of the user equipment; and
wherein the program further includes instructions to allocate, to the user equipment according to the access preamble sequence of the user equipment, an uplink grant greater than or equal to the quantity of bytes that are sent at the request of the user equipment.
